(19) United States
(12) Patent Application Publication
(10) Pub. No.: US 2012/0227217 A1
(43) Pub. Date: Sep. 13, 2012

(54) Hinge device for rotatable members

(75) Inventor: Hsin Hao Chen, Taipei (TW)

(73) Assignee: Kernan Technology Co., Ltd.

(21) Appl. No.: 12/932,898

(22) Filed: Mar. 9, 2011

(51) Int. Cl. E05D 3/06; E05D 5/12

(52) U.S. Cl. 16/366; 16/380

(57) ABSTRACT

A portable apparatus includes a base rotatable member having a chamber and a compartment, a cover rotatable member having a space and a cavity, one or more anchors engaged in the chamber of the base rotatable member and having a curved channel formed in an arm, the cover rotatable member includes a pivot shaft engaged in the channel of the arm for pivotally connecting the rotatable members together, a linking device includes two coupling devices attached to the rotatable members and pivotally connected together with a pivot axle for connecting the coupling devices together and for solidly and stably coupling the rotatable members together, and for receiving and protecting the linking device and the anchors.

### BACKGROUND OF THE INVENTION

1. Field of the Invention

The present invention relates to a hinge or joint device, and more particularly to a hinge or joint device suitably received or contained or engaged in two pivotal or rotatable members or a portable apparatus for suitably and pivotally or rotatably connecting or coupling the two pivotal or rotatable members of the portable apparatus together and for preventing the hinge or joint device from being scrapped or scrubbed or contacted or damaged by the other objects.

2. Description of the Prior Art

Various kinds of typical hinge or joint devices have been developed and provided for pivotally or rotatably connecting or coupling two pivotal or rotatable members of a portable apparatus together, such as a screen or display member for a personal computer or a portable computer, a stand for a portable television set, an adjustable lamp with support arms, electric goods with a lid or the like, and for allowing the two pivotal or rotatable members to be pivoted or rotated or opened or closed relative to each other, and normally comprise two pivot or joint elements attached or mounted or secured to the two pivotal or rotatable members respectively and pivotally or rotatably connected or coupled together.

For example, U.S. Pat. No. 4,986,507 to Chiang, U.S. Pat. No. 5,018,244 to Hino, U.S. Pat. No. 5,037,231 to Kitamura, U.S. Pat. No. 5,075,929 to Chung, U.S. Pat. No. 5,230,569 to Sheedy, and U.S. Pat. No. 5,333,356 to Katagiri disclose several of the typical hinge or joint devices each comprising two pivot or joint elements attached or mounted or secured to two pivotal or rotatable members of a portable apparatus respectively and pivotally or rotatably connected or coupled together for pivotally or rotatably connecting or coupling the two pivotal or rotatable members together and for allowing the two pivotal or rotatable members to be pivoted or rotated or opened or closed relative to each other.

However, the typical hinge or joint devices normally include a relatively weak structure that may not be used to solidly and stably connect or couple the two pivotal or rotatable members together and may be easily broken or damaged after use.

The present invention has arisen to mitigate and/or obviate the afore-described disadvantages of the conventional hinge or joint devices for pivotal or rotatable members.

### SUMMARY OF THE INVENTION

The primary objective of the present invention is to provide a hinge or joint device to be suitably received or contained or engaged in two pivotal or rotatable members of a portable apparatus for suitably and pivotally or rotatably connecting or coupling the two pivotal or rotatable members together and for preventing the hinge or joint device from being scrapped or scrubbed or contacted or damaged by the other objects.

In accordance with one aspect of the invention, there is provided a portable apparatus comprising a first rotatable member including a chamber and a first compartment formed therein, a second rotatable member including a first space and a first cavity formed therein for aligning with the chamber and the first compartment of the first rotatable member respectively, a first anchor engaged in the chamber of the first rotatable member and secured to the first rotatable member, and including an arm extended therefrom and extended out of the chamber of the first rotatable member for selectively extending into the first space of the second rotatable member, and including a curved channel formed in the arm, the second rotatable member including a pivot shaft slidably engaged in the channel of the arm for pivotally connecting the first and the second rotatable members together and for guiding and limiting the first and the second rotatable members to rotate relative to each other, and a first linking device including a first coupling device attached to the first rotatable member, and a second coupling device attached to the second rotatable member and pivotally connected to the first coupling device with a first pivot axle for connecting the first and the second coupling devices together and for coupling the first and the second rotatable members together.

The first coupling device includes a seat engaged in the first compartment of the first rotatable member and secured to the first rotatable member, and at least one bar pivotally coupling the seat to the pivot axle. The seat includes at least one flap extended therefrom and pivotally connected to the bar with a pivot pin.

The second coupling device includes a bracket engaged in the first cavity of the second rotatable member and secured to the second rotatable member, and at least one lever pivotally coupling the bracket to the pivot axle. The bracket includes at least one ear extended therefrom and pivotally connected to the lever with a pivot rod. The first linking device includes a barrel having a bore formed therein for engaging with the first pivot axle.

One or more second linking devices may further be provided and each include a third coupling device attached to the first rotatable member, and a fourth coupling device attached to the second rotatable member and pivotally connected to the third coupling device with a second pivot axle for connecting the third and the fourth coupling devices together and for coupling the first and the second rotatable members together.

The first rotatable member includes a second compartment formed therein, the second rotatable member including a second space and a second cavity formed therein for aligning with the chamber and the second compartment of the first rotatable member respectively, the third coupling device includes a seat engaged in the second compartment of the first rotatable member and secured to the first rotatable member, and at least one bar pivotally coupling the seat to the second pivot axle. The seat includes at least one flap extended therefrom and pivotally connected to the bar with a pivot pin.

The fourth coupling device includes a bracket engaged in the second cavity of the second rotatable member and secured to the second rotatable member, and at least one lever pivotally coupling the bracket to the second pivot axle. The bracket includes at least one ear extended therefrom and pivotally connected to the lever with a pivot rod. The second linking device includes a barrel having a bore formed therein for engaging with the second pivot axle.

One or more second anchors may further be provided and engaged in the chamber of the first rotatable member and secured to the first rotatable member, and including a second arm extended from the second anchor and extended out of the chamber of the first rotatable member, and including a curved channel formed in the second arm for slidably engaging with the pivot shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a hinge or joint device for a portable apparatus in accordance with the present invention;

FIG. 2 is a side plan schematic view of the hinge or joint device for the portable apparatus;

FIG. 3 is a partial exploded view of the hinge or joint device for the portable apparatus;

FIG. 4 is another partial exploded view of the hinge or joint device for the portable apparatus;

FIG. 5 is a perspective view of the hinge or joint device for the portable apparatus; and

FIGS. 6, 7, 8 are enlarged partial side plan schematic views illustrating the operation of the hinge or joint device for the portable apparatus.

### DETAILED DESCRIPTION OF THE PREFERRED EMBODIMENT

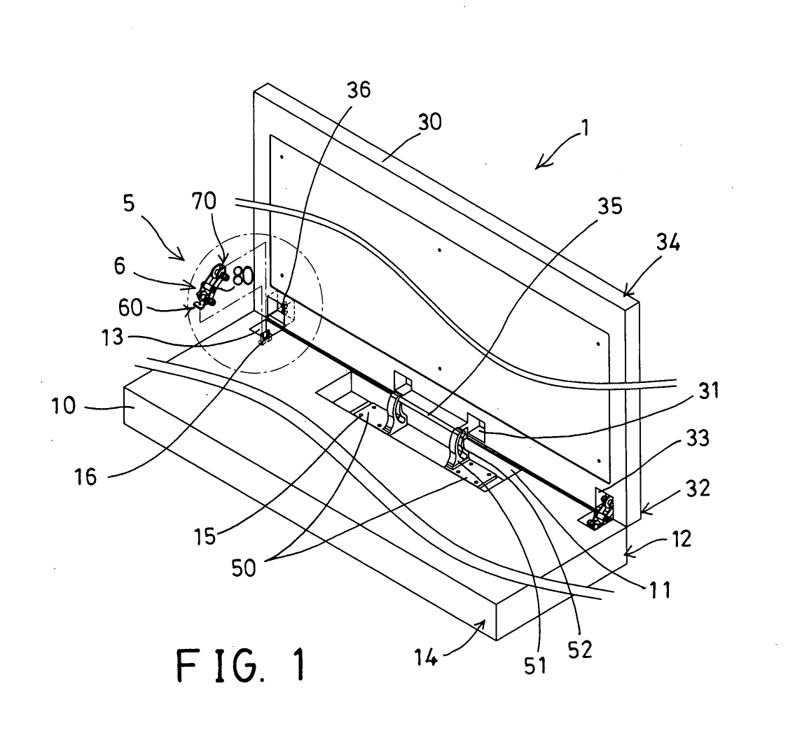

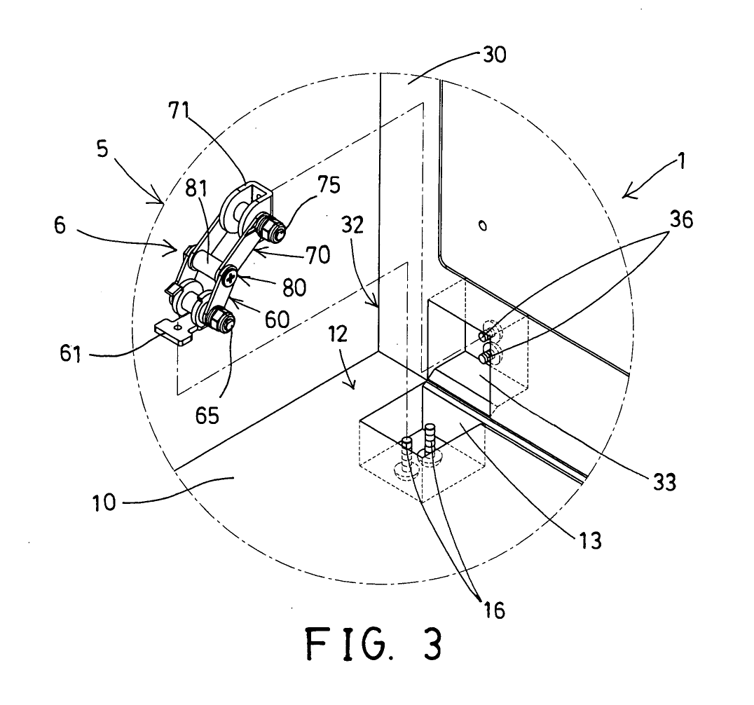

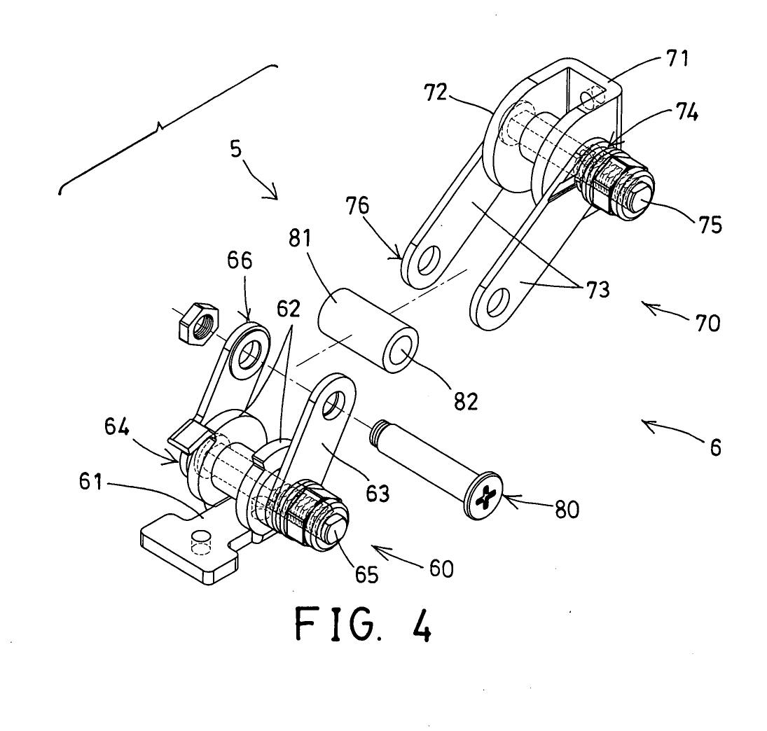

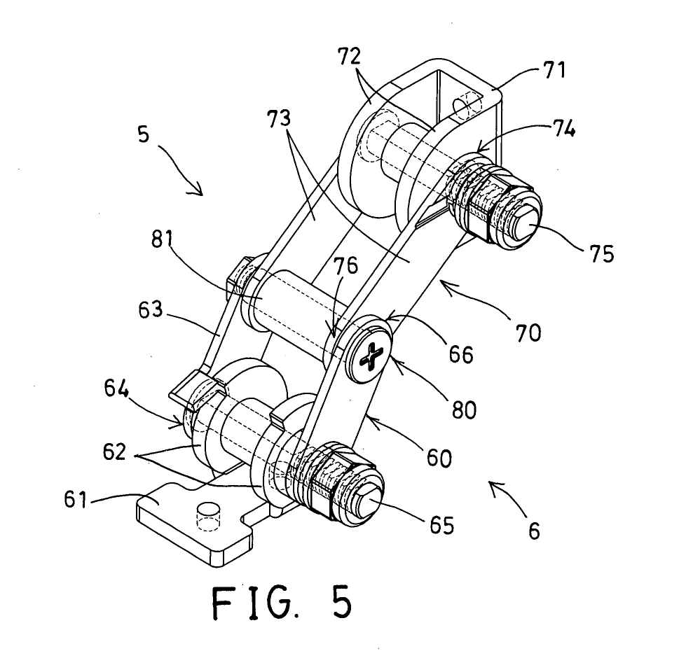

Referring to the drawings, and initially to FIGS. 1-3, a hinge or joint device 5 in accordance with the present invention is developed and provided for pivotally or rotatably connecting or coupling two pivotal or rotatable members 10, 30, such as a first rotatable member 10 and a second rotatable member 30 of a portable apparatus 1 together, such as a screen or display member for a personal computer or a portable computer, a stand for a portable television set, an adjustable lamp with support arms, electric goods with a lid or the like, and for allowing the two pivotal or rotatable members 10, 30 to be pivoted or rotated or opened or closed relative to each other, and for allowing the hinge or joint device 5 to be suitably received or contained or engaged in the pivotal or rotatable members 10, 30 and for preventing the hinge or joint device 5 from being scrapped or scrubbed or contacted or damaged by the other objects.

The first rotatable member 10 of the portable apparatus 1 comprises a chamber 11 formed or provided therein, such as formed in the middle portion of a rear portion 12 thereof, and one or more (such as two) compartments 13 formed or provided therein, such as formed in the side portions 14 of the rear portion 12 thereof. The second rotatable member 30 of the portable apparatus 1 includes one or more (such as two) spaces 31 formed or provided therein, such as formed in the middle portion of a lower portion 32 thereof for aligning with the chamber 11 of the first rotatable member 10, and one or more (such as two) cavities 33 formed or provided therein, such as formed in the side portions 34 of the lower portion 32 thereof for aligning with the compartments 13 of the first rotatable member 10 respectively.

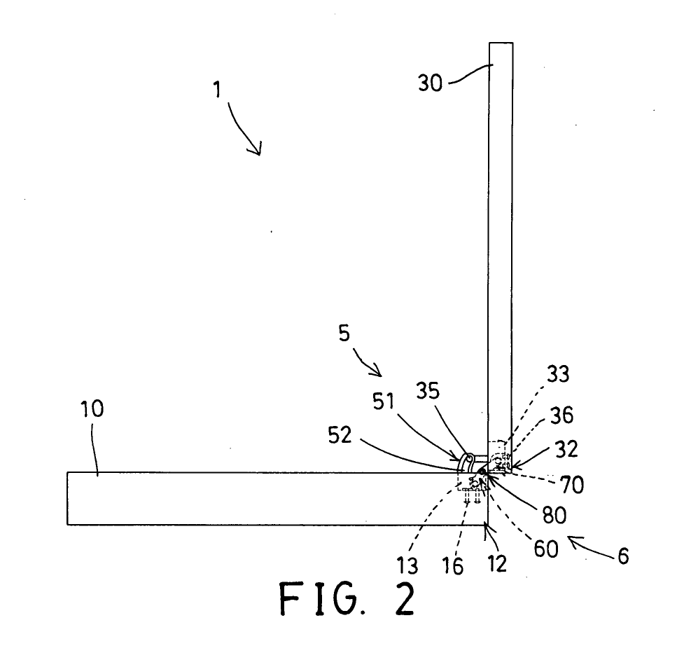

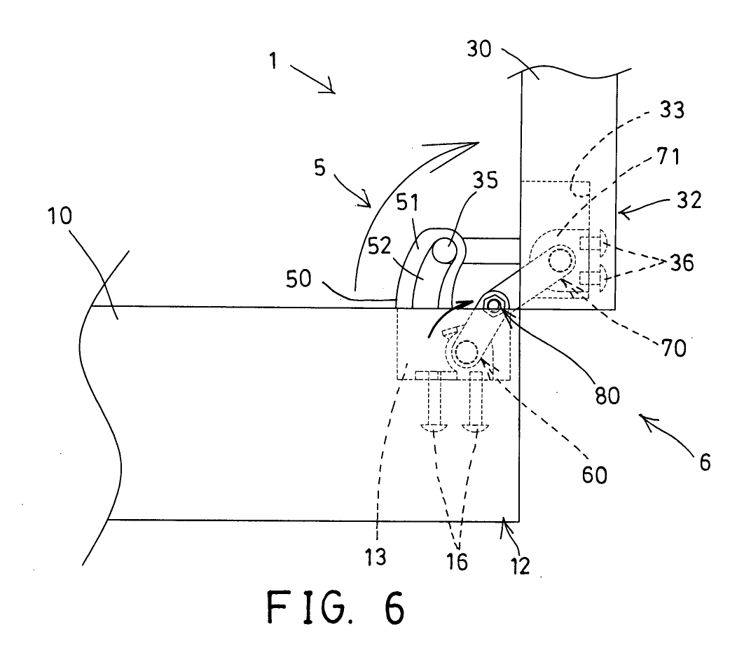

The hinge device 5 includes one or more (such as two) retainers or anchors 50 disposed or attached or mounted or received or engaged in the chamber 11 of the first rotatable member 10, and secured to the first rotatable member 10 with one or more latches or fasteners 15 or the like, the anchors 50 each include an extension or arm 51 extended outwardly therefrom and extended out of the chamber 11 of the first rotatable member 10 (FIGS. 2, 6-7), and each include a curved groove or channel 52 formed in the respective arm 51. The second rotatable member 30 of the portable apparatus 1 includes a pivot shaft 35 extended outwardly therefrom and slidably received or engaged in the channels 52 of the arms 51 for pivotally or rotatably connecting or coupling the rotatable members 10, 30 together and for guiding or limiting the rotatable members 10, 30 to pivot or rotate relative to each other.

The hinge device 5 further includes one or more (such as two) linking devices 6 attached or mounted or secured or coupled between the rotatable members 10, 30 for further solidly and stably connecting or coupling the rotatable members 10, 30 together and for forming a solid and stable structure to solidly and stably connect or couple the rotatable members 10, 30 together. For example, the linking devices 6 each include two coupling devices 60, 70 to be attached or mounted or secured to the rotatable members 10, 30 respectively and to be pivotally or rotatably connected or coupled together with a pivot axle 80 for pivotally or rotatably connecting or coupling the coupling devices 60, 70 together and for further solidly and stably connecting or coupling the rotatable members 10, 30 together.

For example, the first coupling device 60 includes a seat 61 disposed or attached or mounted or received or engaged in the respective compartment 13 of the first rotatable member 10 and secured to the first rotatable member 10 with one or more latches or fasteners 16 or the like, and includes one or more (such as two) flaps 62 extended outwardly therefrom and parallel to each other, and one or more (such as two) bars 63 having one end 64 pivotally or rotatably connected or coupled to the flaps 62 of the seat 61 with a pivot pin 65 and having the other end 66 pivotally or rotatably connected or coupled to the pivot axle 80. It is preferable, but not necessarily that a barrel 81 is further provided and includes a bore 82 formed therein for receiving or engaging with the pivot axle 80, and the barrel 81 is attached or mounted or engaged between the bars 63 for suitably separating the bars 63 from each other.

The second coupling device 70 includes a bracket 71 disposed or attached or mounted or received or engaged in the respective cavity 33 of the second rotatable member 30 and secured to the second rotatable member 30 with one or more latches or fasteners 36 or the like, and includes one or more (such as two) ears 72 extended outwardly therefrom and parallel to each other, and one or more (such as two) levers 73 having one end 74 pivotally or rotatably connected or coupled to the ears 72 of the bracket 71 with a pivot rod 75 and having the other end 76 pivotally or rotatably connected or coupled to the pivot axle 80. The other ends 76 of the levers 73 may be attached or mounted or engaged between the bars 63 and the barrel 81, or the other ends 66 of the bars 63 may be attached or mounted or engaged between the levers 73 and the barrel 81.

In operation, as shown in FIGS. 1-2 and 6, the second rotatable member 30 may be pivoted or rotated or opened relative to the first rotatable member 10 to an open or working position where the second rotatable member 30 is substantially perpendicular to the first rotatable member 10, the pivot shaft 35 of the second rotatable member 30 is slidably received or engaged in the channels 52 of the arms 51 for pivotally or rotatably connecting or coupling the rotatable members 10, 30 together and for guiding or limiting or determining the rotational movement of the second rotatable member 30 relative to the first rotatable member 10. The pivotal coupling of the coupling devices 60, 70 may further guide or limit or determine the rotational movement of the second rotatable member 30 relative to the first rotatable member 10.

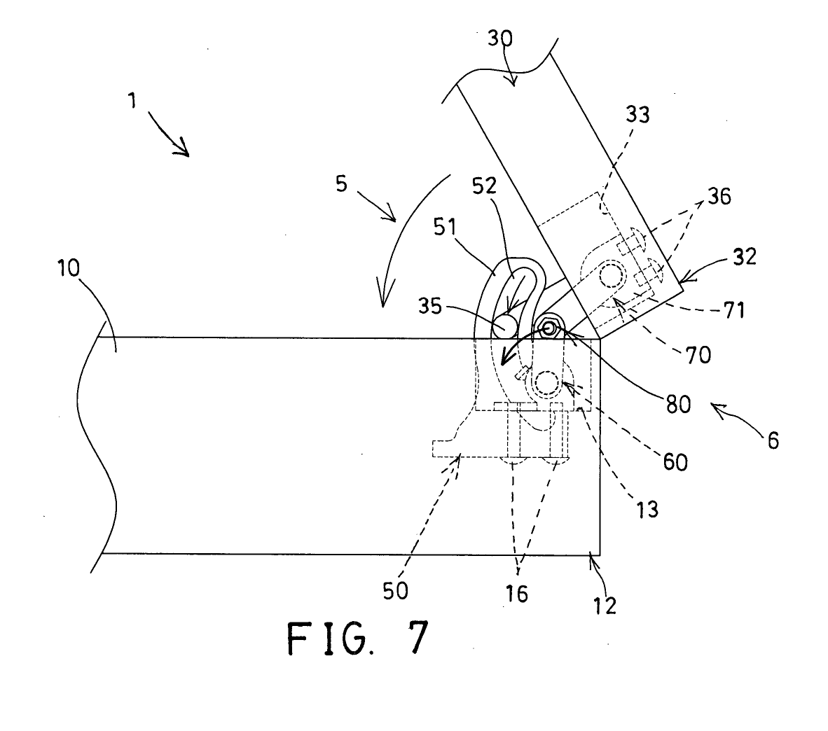

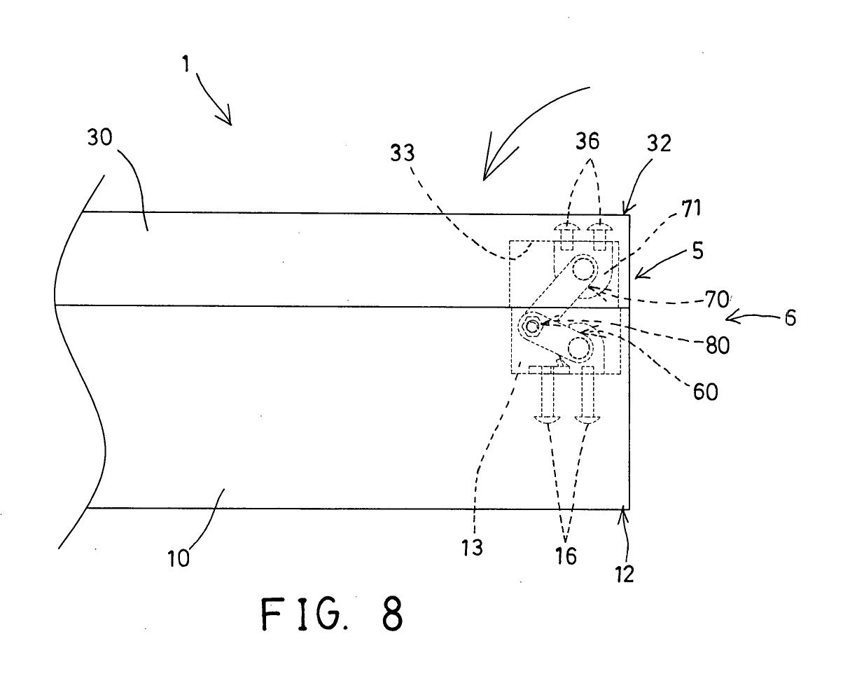

As shown in FIG. 7, when the second rotatable member 30 is pivoted or rotated or moved relative to and toward the first rotatable member 10, the pivot shaft 35 of the second rotatable member 30 may also be guided or limited to move along the channels 52 of the arms 51 for guiding or limiting the rotatable members 10, 30 to pivot or rotate relative to each other. As shown in FIG. 8, when the second rotatable member 30 is pivoted or rotated or moved relative to and toward the first rotatable member 10 to a folded or storing or receiving position where the second rotatable member 30 is substantially parallel to the first rotatable member 10 and contacted or engaged with the first rotatable member 10, the coupling devices 60, 70 of the linking devices 6 may be suitably received or contained or engaged in the compartments 13 and the cavities 33 of the rotatable members 10, 30 and for preventing the hinge device 5 from being scrapped or scrubbed or contacted or damaged by the other objects. The arms 51 may be partially extended and received or contained or engaged in the spaces 31 of the second rotatable member 30 when the rotatable members 10, 30 are contacted or engaged with each other at the folded or storing or receiving position.

Accordingly, the hinge device for a portable apparatus in accordance with the present invention may be provided for being suitably received or contained or engaged in two pivotal or rotatable members and for suitably and pivotally or rotatably connecting or coupling the two pivotal or rotatable members of a portable apparatus together and for preventing the hinge or joint device from being scrapped or scrubbed or contacted or damaged by the other objects.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A portable apparatus comprising:
a first rotatable member including a chamber and a first compartment formed therein,
a second rotatable member including a first space and a first cavity formed therein for aligning with said chamber and said first compartment of said first rotatable member respectively,
a first anchor engaged in said chamber of said first rotatable member and secured to said first rotatable member, and including an arm extended therefrom and extended out of said chamber of said first rotatable member for selectively extending into said first space of said second rotatable member, and including a curved channel formed in said arm,
said second rotatable member including a pivot shaft slidably engaged in said channel of said arm for pivotally connecting said first and said second rotatable members together and for guiding and limiting said first and said second rotatable members to rotate relative to each other, and
a first linking device including a first coupling device attached to said first rotatable member, and a second coupling device attached to said second rotatable member and pivotally connected to said first coupling device with a first pivot axle for connecting said first and said second coupling devices together and for coupling said first and said second rotatable members together.

2. The portable apparatus as claimed in claim 1, wherein said first coupling device includes a seat engaged in said first compartment of said first rotatable member and secured to said first rotatable member, and at least one bar pivotally coupling said seat to said pivot axle.

3. The portable apparatus as claimed in claim 2, wherein said seat includes at least one flap extended therefrom and pivotally connected to said at least one bar with a pivot pin.

4. The portable apparatus as claimed in claim 1, wherein said second coupling device includes a bracket engaged in said first cavity of said second rotatable member and secured to said second rotatable member, and at least one lever pivotally coupling said bracket to said pivot axle.

5. The portable apparatus as claimed in claim 4, wherein said bracket includes at least one ear extended therefrom and pivotally connected to said at least one lever with a pivot rod.

6. The portable apparatus as claimed in claim 1, wherein said first linking device includes a barrel having a bore formed therein for engaging with said first pivot axle.

7. The portable apparatus as claimed in claim 1 further comprising at least one second linking device including a third coupling device attached to said first rotatable member, and a fourth coupling device attached to said second rotatable member and pivotally connected to said third coupling device with a second pivot axle for connecting said third and said fourth coupling devices together and for coupling said first and said second rotatable members together.

8. The portable apparatus as claimed in claim 7, wherein said first rotatable member includes a second compartment formed therein, said second rotatable member including a second space and a second cavity formed therein for aligning with said chamber and said second compartment of said first rotatable member respectively, said third coupling device includes a seat engaged in said second compartment of said first rotatable member and secured to said first rotatable member, and at least one bar pivotally coupling said seat to said second pivot axle.

9. The portable apparatus as claimed in claim 8, wherein said seat includes at least one flap extended therefrom and pivotally connected to said at least one bar with a pivot pin.

10. The portable apparatus as claimed in claim 8, wherein said fourth coupling device includes a bracket engaged in said second cavity of said second rotatable member and secured to said second rotatable member, and at least one lever pivotally coupling said bracket to said second pivot axle.

11. The portable apparatus as claimed in claim 10, wherein said bracket includes at least one ear extended therefrom and pivotally connected to said at least one lever with a pivot rod.

12. The portable apparatus as claimed in claim 7, wherein said at least one second linking device includes a barrel having a bore formed therein for engaging with said second pivot axle.

13. The portable apparatus as claimed in claim 1 further comprising at least one second anchor engaged in said chamber of said first rotatable member and secured to said first rotatable member, and including a second arm extended from said at least one second anchor and extended out of said chamber of said first rotatable member, and including a curved channel formed in said second arm for slidably engaging with said pivot shaft.
